(19) United States
(12) Patent Application Publication
(10) Pub. No.: US 2022/0180677 A1
(43) Pub. Date: Jun. 9, 2022

(54) ALIGHTING POINT GUIDE SYSTEM

(71) Applicant: TOYOTA JIDOSHA KABUSHIKI KAISHA, Toyota-shi (JP)

(72) Inventors: Yoko SAKURAI, Kariya- shi (JP); Masaru OHASHI, Kariya- shi (JP); Ken ISHIKAWA, Kariya- shi (JP); Takashige HORI, Aisai-shi (JP); Masaru WAKABAYASHI, Nagoyo-shi (JP); Shin MAEYAMADA, Kariya- shi (JP)

(73) Assignee: TOYOTA JIDOSHA KABUSHIKI KAISHA, Toyota-shi (JP)

(21) Appl. No.: 17/456,412

(22) Filed: Nov. 24, 2021

(30) Foreign Application Priority Data
Dec. 9, 2020 (JP) 2020-203997

(51) Int. Cl. G07C 5/08; G06Q 10/02; G06Q 50/30; G07C 5/00

(52) U.S. Cl. CPC G07C 5/0841; G07C 5/008; G06Q 50/30; G06Q 10/02

(57) ABSTRACT

An alighting point guide system includes an acquisition portion configured to acquire an alighting point guide request from an occupant of a vehicle, and a guide portion configured to provide a guide to an alighting point. When the number of occupants of the vehicle as a transmission source of the alighting point guide request is larger than a reference number set in advance, the guide portion selects, as the alighting point, a point where at least either one value of a statistic value about a door-open time detected previously and a statistic value about the number of times of door opening that is detected previously is equal to or more than a threshold with preference to a point where the at least either one value is less than the threshold.

### CROSS-REFERENCE TO RELATED APPLICATION

This application claims priority to Japanese Patent Application No. 2020-203997 filed on Dec. 9, 2020, incorporated herein by reference in its entirety.

### BACKGROUND

### 1. Technical Field

The present disclosure relates to an alighting point guide system.

### 2. Description of Related Art

In the related art, in a pickup and drop-off service by a vehicle, the vehicle is stopped on a roadside so that people get in the vehicle or people get off the vehicle. In this regard, Japanese Unexamined Patent Application Publication No. 2020-98524 (JP 2020-98524 A) describes a technology to store position information on a place where a boarding-alighting vehicle behavior occurs, based on vehicle information acquired from a probe vehicle.

### SUMMARY

For example, in a case where a plurality of occupants rides in a rear seat, some of the occupants may get off the vehicle from a door on the road side. On this account, a road with a relatively small traffic volume is desirable as a stop position for alighting. Meanwhile, in a case where only one occupant sitting on a front passenger seat gets off the vehicle, the occupant does not get off the vehicle from the door on the road side. Accordingly, the vehicle can stop in a road with a relatively large traffic volume. As such, a point suitable for parking or stopping a vehicle to drop off occupants may vary depending on the number of the occupants.

The present disclosure is accomplished in view of the above problem, and an object of the present disclosure is to raise the possibility of providing a guide to an alighting point suitable for the number of occupants.

In order to achieve the above object, an alighting point guide system according to the present disclosure includes an acquisition portion and a guide portion. The acquisition portion is configured to acquire an alighting point guide request from an occupant of a vehicle. The guide portion is configured to provide a guide to an alighting point. In a case where the number of occupants of the vehicle as a transmission source of the alighting point guide request is larger than a reference number set in advance, the guide portion selects, as the alighting point, a point where at least either one value of a statistic value about a door-open time detected previously and a statistic value about the number of times of door opening that is detected previously is equal to or more than a threshold, with preference to a point where the at least either one value is less than the threshold. The door-open time is a period during which a door of a vehicle is opened. The number of times of door opening is the number of times a door of a vehicle is opened.

In a case where the number of the occupants is more than the reference number, the alighting point guide system selects, as the alighting point, a point where at least either one value of the statistic value about the door-open time and the statistic value about the number of times of door opening is the threshold or more, with preference to a point where the at least either one value is less than the threshold. Accordingly, it is possible to raise the possibility of providing a guide to an alighting point suitable for the number of occupants.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view illustrating configurations of a first in-vehicle system, a second in-vehicle system, and an alighting point guide system;

FIG. 2A is a view illustrating an exemplary data configuration of a vehicle information DB;

FIG. 2B is a view illustrating an exemplary data configuration of a boarding-alighting table;

FIG. 3 is a flowchart illustrating an information registration process; and

FIG. 4 is a flowchart illustrating an alighting point guide process.

### DETAILED DESCRIPTION OF EMBODIMENTS

An embodiment will be described in accordance with the following order:

(1) Configurations of First In-vehicle System, Second In-vehicle System, and Alighting Point Guide System;

(2) Information Registration Process;

(3) Alighting Point Guide Process; and

(4) Other Embodiments.

(1) Configurations of First In-vehicle System, Second In-vehicle System, and Alighting Point Guide System

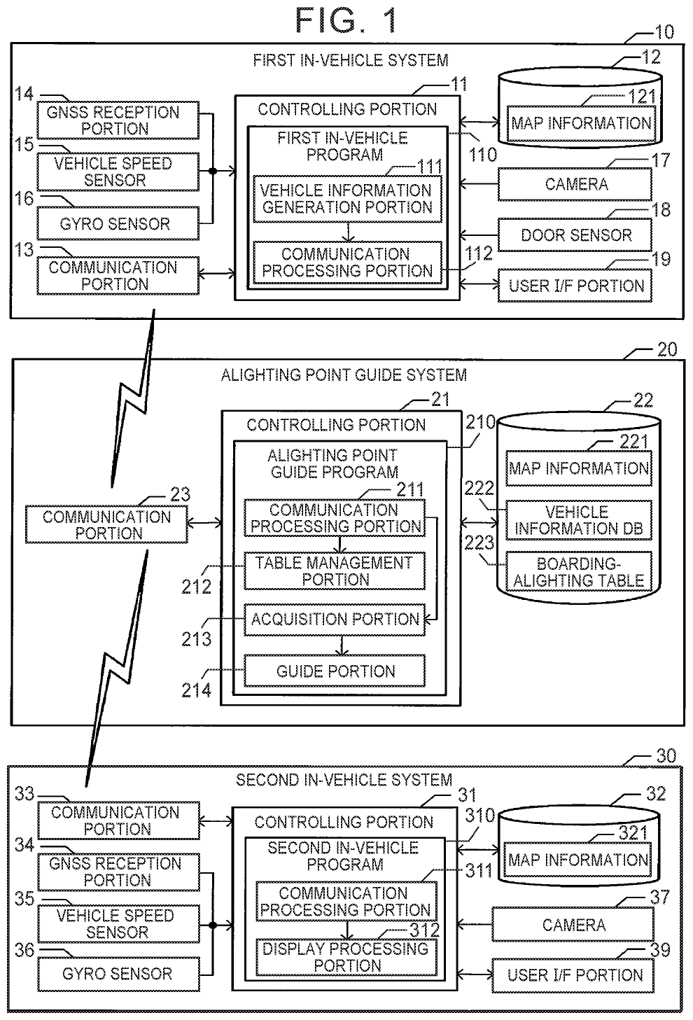

FIG. 1 is a block diagram illustrating configurations of a first in-vehicle system 10, an alighting point guide system 20, and a second in-vehicle system 30. The first in-vehicle system 10 is a system provided in a vehicle (a probe vehicle) and configured to transmit vehicle information on the vehicle provided with the first in-vehicle system 10 to the alighting point guide system 20. Here, the vehicle information is information indicative of the behavior of the vehicle, e.g., the position of the vehicle, the vehicle speed of the vehicle, the open-closed state of a door of the vehicle, or the like. The vehicle information will be described later. The alighting point guide system 20 is a server apparatus configured to specify an alighting point based on the vehicle information received from the first in-vehicle system 10 and cause the second in-vehicle system 30 to provide a guide to the alighting point. Here, the alighting point is a point where a vehicle is parked or stopped to drop off an occupant from the vehicle. The alighting point guide system 20 of the present embodiment manages alighting points per link unit. That is, points included in one link are regarded as the same alighting point, and points in different links are regarded as different alighting points. Note that two links corresponding to two different advancing directions are distinguished from each other. The second in-vehicle system 30 is a system provided in a vehicle and configured to provide a guide to an alighting point. The vehicle provided with the second in-vehicle system 30 can be a pickup vehicle that provides a service to take an occupant to a predetermined location, a general vehicle, or the like, but the vehicle is not limited to any type of vehicle in particular.

In FIG. 1, one first in-vehicle system 10 and one second in-vehicle system 30 are illustrated, but the alighting point guide system 20 receives respective pieces of vehicle information from a plurality of first in-vehicle systems 10. Further, the alighting point guide system 20 causes a plurality of second in-vehicle systems 30 to provide a guide to an alighting point.

The first in-vehicle system 10 includes a controlling portion 11 including a CPU, a RAM, a ROM, and so on, a recording medium 12, and a communication portion 13. The controlling portion 11 can execute various programs stored in the recording medium 12 or the ROM. The controlling portion 11 of the present embodiment can execute a first in-vehicle program 110 as one of these programs. By the process of the first in-vehicle program 110, the controlling portion 11 generates vehicle information and transmits the vehicle information to the alighting point guide system 20 via the communication portion 13. The communication portion 13 is a device via which wireless communication with external devices is performed. Transmission and reception of information between the controlling portion 11 and the alighting point guide system 20 are performed via the communication portion 13.

Map information 121 is stored in the recording medium 12. The map information 121 includes node data indicative of positions of nodes corresponding to endpoints of a road section, shape interpolation point data indicative of positions or the like of shape interpolation points to specify the shape of a road between nodes, link data indicative of a link that connects nodes to each other, and so on. Here, a node corresponds to an intersection, and a link corresponds to a road section from an intersection to another intersection. The map information 121 is used for specification of the position of the vehicle, route search to a destination, route guide to the destination, and so on. In the present embodiment, the link data includes information indicative of a direction where the vehicle is advanceable on a road section indicated by the link data.

The first in-vehicle system 10 further includes a GNSS reception portion 14, a vehicle speed sensor 15, a gyro sensor 16, a camera 17, a door sensor 18, and a user I/F portion 19. The GNSS reception portion 14 is a device configured to receive a signal from a global navigation satellite system. The GNSS reception portion 14 receives an electric wave from a navigation satellite and outputs, via an interface (not illustrated), a signal based on which the position of the vehicle is calculated. The controlling portion 11 acquires the position of the vehicle by acquiring this signal. The vehicle speed sensor 15 outputs a signal corresponding to the rotation speed of wheels provided in the vehicle. The controlling portion 11 acquires the vehicle speed by acquiring this signal via an interface (not illustrated).

The gyro sensor 16 detects an angular acceleration on turning of the vehicle on a horizontal plane and outputs a signal corresponding to the orientation of the vehicle. The controlling portion 11 acquires the advancing direction of the vehicle by acquiring this signal. The vehicle speed sensor 15, the gyro sensor 16, and so on are used to specify the travel trajectory of the vehicle. In the present embodiment, the controlling portion 11 specifies the position of the vehicle based on a departure place of the vehicle and the travel trajectory and corrects, based on the output signal from the GNSS reception portion 14, the position of the vehicle that is specified based on the departure place and the travel trajectory.

The camera 17 is provided in a vehicle cabin of the vehicle provided with the first in-vehicle system 10 and configured to capture images of all seats inside the vehicle cabin. The camera 17 includes a first camera configured to capture an image of a driver seat and a front passenger seat, and a second camera configured to capture an image of a rear seat, for example. Note that, as long as the first in-vehicle system 10 can obtain captured images of all the seats, the number of cameras provided in the first in-vehicle system 10 and respective installation positions of the cameras are not limited.

The door sensor 18 detects opening and closing of all doors provided in the vehicle provided with the first in-vehicle system 10. The user I/F portion 19 is an interface portion configured to receive an instruction from a user and to provide various pieces of information to the user. The user I/F portion 19 includes a touch-panel display, a switch or the like, a speaker, and so on. That is, the user I/F portion 19 includes an output portion for outputting an image or audio, and an input portion for receiving an instruction from the user.

The first in-vehicle program 110 to be executed by the controlling portion 11 of the first in-vehicle system 10 is a program causing a computer of the first in-vehicle system 10 to function as a vehicle information generation portion 111 and a communication processing portion 112. In the following description, processes to be executed by the vehicle information generation portion 111 and the communication processing portion 112 are processes to be implemented when the controlling portion 11 (CPU) executes the first in-vehicle program 110, that is, processes to be executed by the controlling portion 11.

The vehicle information generation portion 111 generates vehicle information on the vehicle provided with the first in-vehicle system 10. More specifically, the vehicle information generation portion 111 specifies the behavior of the vehicle at regular intervals. The vehicle information generation portion 111 generates the vehicle information such that information indicative of the behavior of the vehicle is associated with a vehicle ID by which the vehicle is identified and a detection time when the behavior is detected.

In the present embodiment, as the behavior of the vehicle, the vehicle information generation portion 111 specifies a vehicle position, a vehicle speed, a door state, and the number of occupants and generates vehicle information indicative of them. As described above, the vehicle information generation portion 111 specifies the vehicle position based on information acquired from respective output signals from the GNSS reception portion 14, the vehicle speed sensor 15, and the gyro sensor 16. The vehicle information generation portion 111 specifies the vehicle speed based on a detection result from the vehicle speed sensor 15, as described above. The vehicle information generation portion 111 specifies the door state based on a detection result from the door sensor 18. The door state is an open-closed state of each door. The controlling portion 11 specifies the number of occupants based on an image captured by the camera 17. The controlling portion 11 performs facial recognition on people by artificial intelligence (AI) or the like and specifies the number of recognized people as the number of occupants (a total number), for example.

Note that the process for the vehicle information generation portion 111 to specify the number of occupants is not limited to the embodiment. As another example, a seat sensor, a seat belt sensor, and so on may be provided in each seat, and the vehicle information generation portion 111 may specify the number of occupants based on detection results from these sensors. As further another example, the number of occupants may be input by the user via the user I/F portion 19.

The communication processing portion 112 transmits and receives information to and from external devices via the communication portion 13. The communication processing portion 112 transmits the vehicle information to the alighting point guide system 20 at regular intervals, for example.

Next will be described the alighting point guide system 20. The alighting point guide system 20 includes a controlling portion 21 including a CPU, a RAM, a ROM, and so on, a recording medium 22, and a communication portion 23. The controlling portion 21 can execute various programs stored in the recording medium 22 or the ROM. The controlling portion 21 of the present embodiment can execute an alighting point guide program 210 as one of these programs. The controlling portion 21 executes the process of the alighting point guide program 210 to cause the second in-vehicle system 30 to provide a guide to an alighting point. The communication portion 23 is a device via which wireless communication with external devices is performed. Transmission and reception of information between the controlling portion 21 and each of the first in-vehicle system 10 and the second in-vehicle system 30 are performed via the communication portion 23.

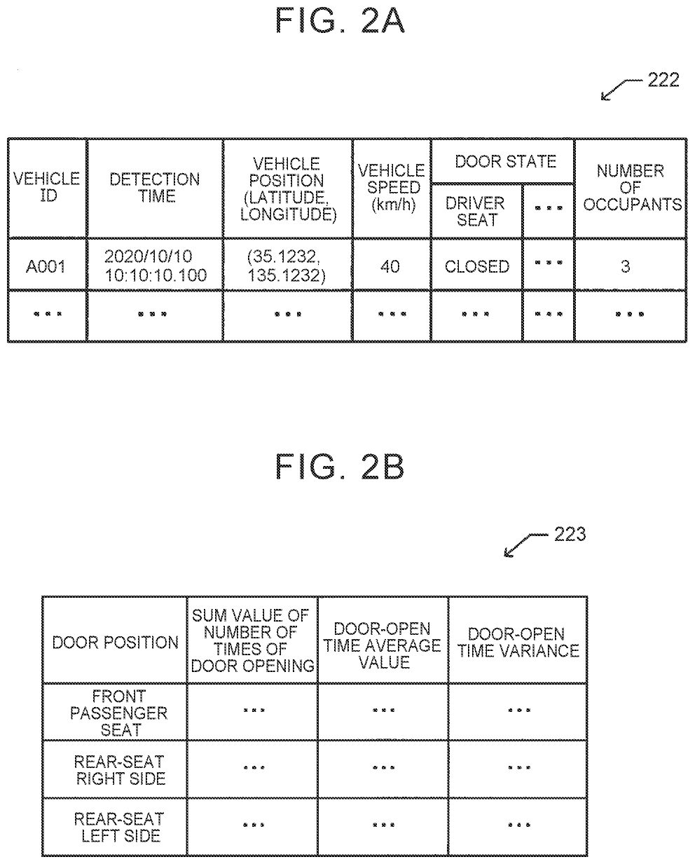

In the recording medium 22, map information 221, a vehicle information DB 222, and a boarding-alighting table 223 are stored. The map information 221 is similar to the map information 121. Pieces of vehicle information transmitted from the first in-vehicle systems 10 at regular intervals are sequentially accumulated in the vehicle information DB 222. FIG. 2A is a view illustrating an exemplary data configuration of the vehicle information DB 222. In FIG. 2A, vehicle information corresponding to one vehicle is illustrated, but pieces of vehicle information corresponding to other vehicles are also stored in the vehicle information DB 222. As described above, the vehicle information includes a vehicle ID, a detection time, a vehicle position, a vehicle speed, a door state, and the number of occupants. Although partially omitted in FIG. 2A, the door state includes an open-closed state on each of a plurality of doors provided in a vehicle.

The boarding-alighting table 223 is a table in which statistic values acquired from the vehicle information DB 222 are stored. FIG. 2B is a view illustrating an exemplary data configuration of the boarding-alighting table 223. In FIG. 2B, a boarding-alighting table corresponding to one point, that is, one link is illustrated, but the boarding-alighting table 223 includes a boarding-alighting table of each of a plurality of points. In the boarding-alighting table, a door position, a sum value of the number of times of door opening, a door-open time average value, and a door-open time variance are stored in association with each other. Here, the door position indicates the position of a door in the vehicle, e.g., a front passenger seat, a rear-seat right side, a rear-seat left side, and so on.

The number of times of door opening indicates the number of times a door is opened previously, and the sum value of the number of times of door opening is a total value of the number of times of door opening. For example, at a given point, the door of the front passenger seat of a vehicle A is opened, and the door of the front passenger seat of a vehicle B is also opened. In this case, “2” is stored in the sum value of the number of times of door opening about the front passenger seat. As such, the sum value of the number of times of door opening indicates a total value, per door, of the number of times the door is opened previously at a given point. Here, the sum value of the number of times of door opening is one example of a statistic value about the number of times of door opening.

The door-open time indicates a period of time during which a door is opened previously at a given point, that is, a period of time from opening of the door to closing of the door. The door-open time average value indicates an average value of door-open times for each door. For example, in a case where a period of time during which the door of the front passenger seat of the vehicle A is opened is three minutes, and a period of time during which the door of the front passenger seat of the vehicle B is opened is one minute, “two minutes” is stored in the door-open time average value about the front passenger seat.

The door-open time variance indicates a variance of the door-open time about each door. As described above, in a case where the number of times of door opening about the front passenger seat is two, and respective door-open times are three minutes and two minutes, “1” is stored in the door-open time variance about the front passenger seat according to (Formula 1). Note that the door-open time average value and the door-open time variance are examples of a statistic value about the door-open time.

{(3−2)²+(1−2)²}/2=1 (Formula 1)

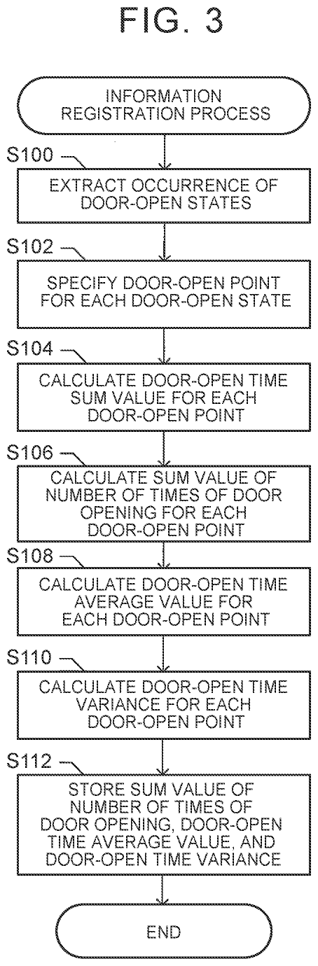

The storage of the statistic values in the boarding-alighting table 223 is performed by the controlling portion 21. The process for the controlling portion 21 to store the statistic values in the boarding-alighting table 223 will be describe in detail with reference to FIG. 3. As described above, in the boarding-alighting table 223, statistic values at respective points where vehicles are parked or stopped previously for boarding and alighting are stored for each door position. Note that, in the present embodiment, the door-open time average value is stored in the boarding-alighting table 223 as a statistic value about the door-open time, but instead of this, a door-open time median may be stored.

In FIG. 1, the alighting point guide program 210 to be executed by the controlling portion 21 of the alighting point guide system 20 is a program causing a computer of the alighting point guide system 20 to function as a communication processing portion 211, a table management portion 212, an acquisition portion 213, and a guide portion 214. In the following description, processes to be executed by the communication processing portion 211, the table management portion 212, the acquisition portion 213, and the guide portion 214 are processes to be implemented when the controlling portion 21 (CPU) executes the alighting point guide program 210, that is, processes to be executed by the controlling portion 21.

The communication processing portion 211 transmits and receives information to and from external devices via the communication portion 23. The communication processing portion 211 receives vehicle information from the first in-vehicle system 10, for example. The table management portion 212 registers statistic values to the boarding-alighting table 223 by referring to the vehicle information DB 222. The acquisition portion 213 acquires an alighting point guide request from the second in-vehicle system 30 via the communication processing portion 211. Here, the alighting point guide request is information including the destination of the vehicle and requesting a guide to an alighting point in the vicinity of the destination. The alighting point guide request also includes the number of occupants in the vehicle provided with the second in-vehicle system 30.

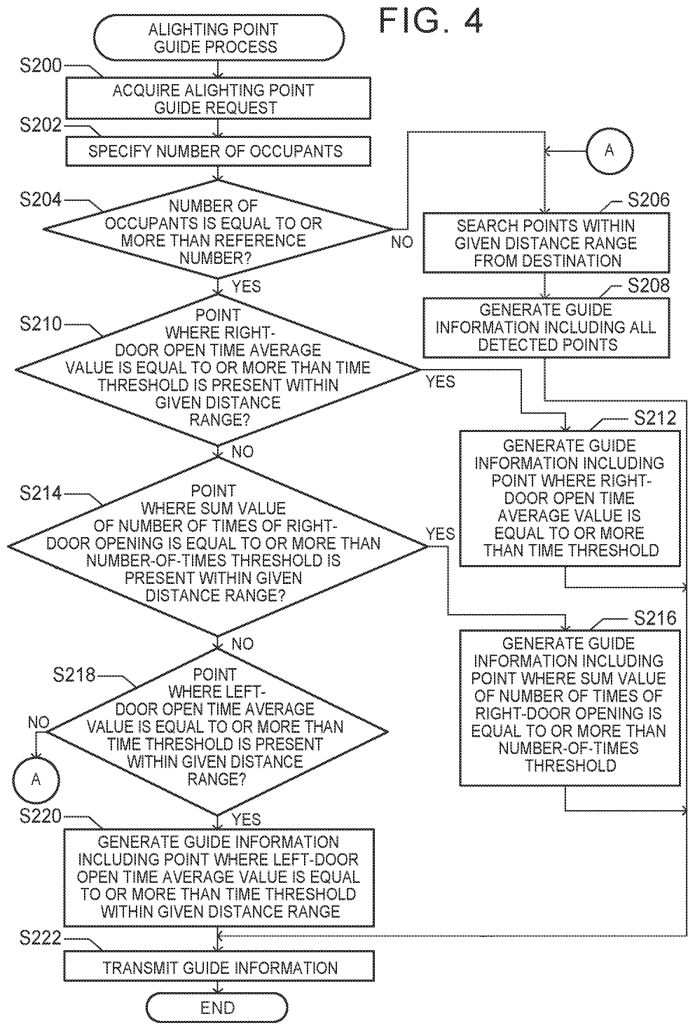

The guide portion 214 specifies an alighting point included in a given distance from the destination included in the alighting point guide request by referring to the boarding-alighting table 223 and causes the second in-vehicle system 30 to provide a guide to the specified alighting point. More specifically, the guide portion 214 transmits, to the second in-vehicle system 30 via the communication processing portion 211, guide information including the specified alighting point so that the second in-vehicle system 30 outputs the guide information. The process of the guide portion 214 will be described later with reference to FIG. 4.

Next will be described the second in-vehicle system 30. The second in-vehicle system 30 includes a controlling portion 31 including a CPU, a RANI, a ROM, and so on, a recording medium 32, and a communication portion 33. The controlling portion 31 can execute various programs stored in the recording medium 32 or the ROM. The controlling portion 31 of the present embodiment can execute a second in-vehicle program 310 as one of these programs. The controlling portion 31 causes a display of a user I/F portion 39 to provide a guide to an alighting point by the process of the second in-vehicle program 310. More specifically, the controlling portion 31 causes the display to display the alighting point. The communication portion 33 is a device via which wireless communication with external devices is performed. Transmission and reception of information between the controlling portion 31 and the alighting point guide system 20 are performed via the communication portion 33.

Map information 321 is stored in the recording medium 32. The map information 321 is similar to the map information 121. The second in-vehicle system 30 further includes a GNSS reception portion 34, a vehicle speed sensor 35, a gyro sensor 36, a camera 37, and the user I/F portion 39. The GNSS reception portion 34, the vehicle speed sensor 35, the gyro sensor 36, the camera 37, and the user I/F portion 39 are similar to the GNSS reception portion 14, the vehicle speed sensor 15, the gyro sensor 16, the camera 17, and the user I/F portion 19 of the first in-vehicle system 10, respectively.

The second in-vehicle program 310 to be executed by the controlling portion 31 of the second in-vehicle system 30 is a program causing a computer of the second in-vehicle system 30 to function as a communication processing portion 311 and a display processing portion 312. In the following description, processes to be executed by the communication processing portion 311 and the display processing portion 312 are processes to be implemented when the controlling portion 31 (CPU) executes the second in-vehicle program 310, that is, processes to be executed by the controlling portion 31.

The communication processing portion 311 transmits and receives information to and from external devices via the communication portion 33. The communication processing portion 311 transmits an alighting point guide request to the alighting point guide system 20, for example. Here, a destination included in the alighting point guide request is input in the user I/F portion 39 by a user. The number of occupants included in the alighting point guide request is specified by the controlling portion 31 based on a captured image from the camera 37. The process for the controlling portion 31 to specify the number of occupants is similar to the process for the controlling portion 11 of the first in-vehicle system 10 to specify the number of occupants based on a captured image from the camera 17. The communication processing portion 311 receives guide information on an alighting point from the alighting point guide system 20, for example. The display processing portion 312 causes the display of the user I/F portion 39 to display various pieces of information as the guide information.

(2) Information Registration Process

FIG. 3 is a flowchart illustrating an information registration process. The information registration process is a process to be executed by the alighting point guide system 20 at regular intervals. Note that, in a case where various values are registered in the boarding-alighting table 223 at the start of the information registration process, the table management portion 212 initializes the values to initial values (zero).

First, the table management portion 212 of the alighting point guide system 20 extracts occurrence of door-open states from pieces of vehicle information by referring to the vehicle information DB 222 (S100). Note that the pieces of vehicle information referred to by the table management portion 212 are pieces of information detected in a given period (e.g., past one month) just before a time point when the process of S100 is executed. More specifically, the table management portion 212 extracts vehicle information in which the door state is “OPEN.” Note that, in a case where the same door of the same vehicle consecutively enters the door state “OPEN” along time series, the table management portion 212 extracts the consecutive door-open states as one door-open state.

Subsequently, the table management portion 212 specifies a door-open point corresponding to each door-open state extracted in S100 (S102). More specifically, the table management portion 212 specifies, as the door-open point, a link including a vehicle position indicated by vehicle information in which the door-open state is detected. Then, the table management portion 212 calculates a door-open time sum value for each door position in each door-open point (S104). Then, the table management portion 212 calculates a sum value of the number of times of door opening for the each door position in the each door-open point (S106). Note that, in pieces of vehicle information on the same vehicle in which the door-open state is detected and the detection times of which are consecutive, the table management portion 212 specifies a period from the earliest time to the latest time as a door-open time corresponding to one door-open state.

Subsequently, the table management portion 212 calculates a door-open time average value for the each door position in the each door-open point by dividing the door-open time sum value by the sum value of the number of times of door opening (S108) Then, the table management portion 212 calculates a door-open time variance for the each door position in the each door-open point based on door-open times corresponding to respective door-open states, the door-open time average value, and the sum value of the number of times of door opening (S110). Subsequently, the table management portion 212 stores, in the boarding-alighting table 223, the sum value of the number of times of door opening, the door-open time average value, and the door-open time variance for the each door position in the each door-open point (S112). Hereby, the information registration process is finished.

Note that, in the present embodiment, the table management portion 212 creates the boarding-alighting table 223 based on pieces of vehicle information detected in a predetermined period such as past one month, for example. Hereby, in a case where a point where vehicles are parked or stopped for boarding or alighting are changed due to a change in the traffic volume of the road, or the like, for example, the change is immediately reflected on the boarding-alighting table 223. Note that, as another example, the table management portion 212 may update pieces of information in the boarding-alighting table 223 based on newly provided vehicle information. In this case, the table management portion 212 registers various statistic values in the boarding-alighting table 223 based on vehicle information detected in a first period. After that, the table management portion 212 updates the various statistic values registered in the first period, based on vehicle information detected in a second period subsequent to the first period. Thus, the table management portion 212 should continue updating the statistic values in the boarding-alighting table 223 at regular intervals.

As such, a point where a door of a vehicle is opened, that is, a point where boarding or alighting is performed is registered in the boarding-alighting table 223. Thus, it is considered that the point where a door is opened is a point where a vehicle is easily parked or stopped and an occupant easily gets off the vehicle. In view of this, the alighting point guide system 20 provides a guide to the point registered in the boarding-alighting table 223 as an alighting point. The following describes an alighting point guide process of providing a guide to an alighting point, with reference to FIG. 4.

(3) Alighting Point Guide Process

FIG. 4 is a flowchart illustrating an alighting point guide process. The alighting point guide process is a process to be executed in a case where the alighting point guide system 20 receives an alighting point guide request from the second in-vehicle system 30. The acquisition portion 213 of the alighting point guide system 20 acquires the alighting point guide request via the communication portion 23 and the communication processing portion 211 (S200). Here, as described above, the alighting point guide request includes the destination and the number of occupants of the vehicle provided with the second in-vehicle system 30 as a transmission source. Subsequently, the guide portion 214 specifies the number of the occupants included in the alighting point guide request (S202).

Then, the guide portion 214 compares the number of the occupants with a reference number (S204). Here, the reference number is a number set in advance in the recording medium 22 or the like and is a value serving as a reference based on which or not whether the number of occupants in a vehicle is large is determined. The reference number may be set to three, for example. Note that the reference number may be set by an administrator or the like. In a case where the number of the occupants is the reference number or more (Y in S204), the guide portion 214 advances the process to S210.

In a case where the number of the occupants is less than the reference number (N in S204), the guide portion 214 searches all points present within a given distance range from the destination included in the alighting point guide request, from among points stored in the boarding-alighting table 223 (S206). Then, the guide portion 214 selects all the points provided in S206 as alighting points and generates guide information including the alighting points (S208). Subsequently, the guide portion 214 causes the communication processing portion 211 to transmit the guide information to the second in-vehicle system 30 (S222). That is, the guide portion 214 causes the second in-vehicle system 30 to provide a guide to the alighting points shown in the guide information. Hereby, the alighting point guide process is finished. As such, in a case where the number of the occupants is less than the reference number, the guide portion 214 can give a user of the second in-vehicle system 30 a guide to the points present within the given distance range from the destination, the points being locations where vehicles are parked or stopped previously for boarding or alighting.

Note that, when the communication processing portion 311 receives the guide information, the display processing portion 312 of the second in-vehicle system 30 causes the display of the user I/F portion 39 to display the guide information. The display processing portion 312 may display, on a map, the destination and the alighting points shown in the guide information, for example. Hereby, the user can check respective positions of the alighting points and also can grasp a positional relationship between the destination and each of the alighting points.

In S210, the guide portion 214 refers to the boarding-alighting table 223 and searches a point present within the given distance range from the destination and having a right-door-open time average value equal to or more than a time threshold. Here, the right-door-open time average value is a door-open time average value about the right door. In the boarding-alighting table 223 illustrated in FIG. 2B, the door-open time average value corresponding to a door position “REAR-SEAT RIGHT SIDE” indicates the right-door-open time average value. The time threshold is a period set in advance. A sufficiently long period for occupants to get off a vehicle is set as the time threshold, for example. In a case where there is a point present within the given distance range from the destination and having a right-door-open time average value equal to or more than the time threshold (Y in S210), the guide portion 214 selects the detected point as an alighting point and generates guide information including the alighting point (S212). Then, the guide portion 214 advances the process to S222. Thus, the guide portion 214 selects, as the alighting point, a point where a statistic value (the right-door-open time average value) about the door-open time of the right door of the vehicle, that is, a door on an on-coming lane side, is equal to or more than the time threshold, with preference to points where the statistic value is less than the time threshold.

Note that, as another example, in S212, in a case where there is a point where a right-door-open time variance (the door-open time variance about the right door) is smaller than a variance threshold, the guide portion 214 may generate guide information including, as the alighting point, only the point where the right-door-open time variance is smaller than the variance threshold. As such, the guide portion 214 may select, as the alighting point, a point where the right-door-open time variance is smaller than the variance threshold with preference to points where the right-door-open time variance is equal to or more than the variance threshold, and the guide portion 214 may provide a guide to the alighting point thus selected. Here, the variance is an index value of a variation degree, and the variance threshold is a value corresponding to a variation threshold. That is, the above process is a process of selecting a point where the variation degree is smaller than the variation threshold.

In the meantime, in a case where, in S210, there is no point present within the given distance range from the destination and having a right-door-open time average value equal to or more than the time threshold (N in S210), the guide portion 214 advances the process to S214. In S214, the guide portion 214 refers to the boarding-alighting table 223 and searches a point present within the given distance range from the destination and having a sum value of the number of times of right-door opening (the sum value of the number of times of door opening about the right door) that is equal to or more than a number-of-times threshold. The number-of-times threshold is a predetermined number of times. The number of times indicating that alighting of occupants is performed frequently is set to the number-of-times threshold, for example. In a case where there is a point present within the given distance range from the destination and having a sum value of the number of times of right-door opening that is equal to or more than the number-of-times threshold (Y in S214), the guide portion 214 generates guide information including the detected point (S216) and then advances the process to S222. Thus, the guide portion 214 selects, as the alighting point, a point where a statistic value (the sum value of the number of times of right-door opening) about the number of times of door opening of the right door of the vehicle, that is, a door on the on-coming lane side, is equal to or more than the number-of-times threshold, with preference to points where the statistic value is less than the number-of-times threshold.

Note that, in the above process, in a case where the points present within the given distance range include a point x1 where the right-door-open time average value is equal to or more than the time threshold and a point x2 where the sum value of the number of times of right-door opening is equal to or more than the number-of-times threshold, the point x1 is preferentially selected as the alighting point by the processes of S210, S212. That is, a point where the right-door-open time average value is equal to or more than the time threshold is selected and notified with preference to a point where the sum value of the number of times of right-door opening is equal to or more than the number-of-times threshold.

In a case where there is no point present within the given distance range from the destination and having a sum value of the number of times of right-door opening that is equal to or more than the number-of-times threshold (N in S214), the guide portion 214 advances the process to S218. In S218, the guide portion 214 refers to the boarding-alighting table 223 and searches a point present within the given distance range from the destination and having a left-door-open time average value (a door-open time average value about the left door) equal to or more than the time threshold. Here, the left-door-open time average value is a door-open time average value about the left door. In a case where there is a point present within the given distance range from the destination and having a left-door-open time average value equal to or more than the time threshold (Y in S218), the guide portion 214 generates guide information including the detected point (S220) and then advances the process to S222.

In a case where there is no point present within the given distance range from the destination and having a left-door-open time average value equal to or more than the time threshold (N in S218), the guide portion 214 advances the process to S206. That is, in this case, the guide portion 214 generates guide information including all points present within the given distance, the points being stored in the boarding-alighting table 223.

Note that, as another example, in a case where there is no point present within the given distance range from the destination and having a left-door-open time average value equal to or more than the time threshold (N in S218), the guide portion 214 may expand the distance range and execute the processes of S210 to S218. Still, in a case where any point cannot be detected as the alighting point, the guide portion 214 may advance the process to S206.

In a case where the number of the occupants is equal to or more than the reference number, some points may be not suitable as alighting points. Such points include a road with a large traffic volume and a road with a large width. In this regard, in a case where the number of the occupants is equal to or more than the reference number, the alighting point guide system 20 of the present embodiment refers to the boarding-alighting table 223 and provides a guide to a point where vehicles are actually parked or stopped previously for boarding or alighting. That is, the alighting point guide system 20 of the present embodiment can raise the possibility of providing a guide to an alighting point suitable for the number of the occupants.

Further, in a case where the number of the occupants is equal to or more than the reference number, the right door, that is, a door on the road side (the on-coming lane side) is more likely to be used for alighting. In this regard, in a case where the number of the occupants is equal to or more than the reference number, the alighting point guide system 20 of the present embodiment provides a guide to a point where the right door is used preferentially from among points where vehicles are actually parked or stopped previously for boarding or alighting. Hereby, it is possible to raise the possibility of providing a guide to a point that has been used for boarding or alighting by use of the right door, that is a point more suitable for alighting.

Further, the alighting point guide system 20 of the present embodiment selects, as the alighting point, a point where the right-door-open time average value is equal to or more than the time threshold from among the points where the right door is used for boarding or alighting. Hereby, it is possible to raise the possibility of providing a guide to a point that has been used for boarding or alighting with sufficient time, that is, a point where the occupants are more likely to get off the vehicle with sufficient time, as the alighting point.

In a case where such a point is not present, the alighting point guide system 20 selects, as the alighting point, a point where the sum value of the number of times of right-door opening is equal to or more than the number-of-times threshold. Hereby, in a case where the alighting point guide system 20 cannot find a point where the occupants are more likely to get off the vehicle with sufficient time, the alighting point guide system 20 can provide a guide to a point that has been sufficiently used for boarding or alighting, that is, a point suitable for alighting

(4) Other Embodiments

The above embodiment is only an example to perform the present disclosure, and other various embodiments can be employed. For example, the alighting point guide system 20 may be a system achieved by a plurality of devices. At least some of the communication processing portion 211, the table management portion 212, the acquisition portion 213, and the guide portion 214 constituting the alighting point guide system 20 may be provided as separate devices. Of course, some constituents in the abovementioned embodiment may be omitted, or the order of the processes may be changed or omitted.

For example, the information registration process and the alighting point guide process may be executed by different devices. In this case, a first device may execute the information registration process, and a second device may receive a boarding-alighting table registered by the first device and execute the alighting point guide process based on the boarding-alighting table. Further, as another example, the second in-vehicle system 30 may receive the boarding-alighting table from the alighting point guide system 20 and execute the alighting point guide process based on the boarding-alighting table. That is, the second in-vehicle system 30 may function as the alighting point guide system.

Further, in the present embodiment, the first in-vehicle system 10 transmits vehicle information, and the second in-vehicle system 30 displays guide information. However, one in-vehicle system provided in one vehicle may execute the process of the first in-vehicle system 10 and the process of the second in-vehicle system 30.

The process (S202 and S204 in FIG. 4) for the second in-vehicle system 30 to determine whether or not the number of the occupants is equal to or more than the reference number, as described in the present embodiment, is not limited to the above embodiment. As another example, the second in-vehicle system 30 includes the door sensor 18, and the controlling portion 31 of the second in-vehicle system 30 specifies the number of the doors opened when the occupants get in the vehicle provided with the second in-vehicle system 30. In a case where the number of the opened doors is equal to or more than a predetermined number such as “3,” for example, the controlling portion 31 determines that the number of the occupants is equal to or more than the reference number, and the controlling portion 31 stores, in the recording medium 32, information indicating that the number of the occupants is the reference number or more. In a case where the number of the opened doors is less than the predetermined number, the controlling portion 31 determines that the number of the occupants is less than the reference number, and the controlling portion 31 stores, in the recording medium 32, information indicating that the number of the occupants is less than the reference number. Then, at the time of transmitting an alighting point guide request, the controlling portion 31 may transmit, to the alighting point guide system 20, the alighting point guide request including information indicating that the number of the occupants is equal to or more than the reference number or indicating that the number of the occupants is less than the reference number, the information being stored in the recording medium 32.

Further, as another example, the controlling portion 31 specifies a door-open time of the door opened when the occupants get in the vehicle. In a case where the door-open time is equal to or more than a threshold set in advance, the controlling portion 31 may determine that the number of the occupants is equal to or more than the reference number, and in a case where the door-open time is less than the threshold, the controlling portion 31 may determine that the number of the occupants is less than the reference number. Then, the controlling portion 31 may store a determination result in the recording medium 32.

In the present embodiment, a point where the right door is opened previously is selected as the alighting point with preference to a point where the left door is opened previously, and a guide to the point where the right door is opened previously is provided. This corresponds to a left-hand traffic road like Japan. The alighting point guide system 20 should select, as the alighting point, a point where the door on the on-coming lane side is opened previously, with preference to a point where the door on a side opposite to the on-coming lane side is opened previously. For example, in a case of a right-hand traffic road like the United States, right and left doors targeted to the process of the present embodiment are reversed to those in the present embodiment.

Note that the alighting point guide system 20 should select, as the alighting point, a point where at least either one value of the right-door-open time average value (the door-open time average value) and the sum value of the number of times of right-door opening (a statistic value about the number of times of door opening) is a threshold or more, with preference to a point where the at least either one value is less than the threshold. Further, the alighting point guide system 20 may set the number-of-times threshold for the sum value of the number of times of door opening to one and may select, as the alighting point, a point where the right door is opened at least once.

Further, the door to be targeted is not limited to the right door. That is, the alighting point guide system 20 may provide a guide to the alighting point based on at least either one value from among respective door-open time average values and respective sum values of the number of times of door opening of all doors provided in the vehicle.

Further, the controlling portion 21 of the alighting point guide system 20 of the present embodiment provides a guide to only a point where at least either one of the door-open time average value and the sum value of the number of times of door opening is the threshold or more. However, the controlling portion 21 is not limited to this. As another example, even in a case where the number of the occupants is equal to or more than the reference number, the controlling portion 21 may provide a guide to all points present within the given distance range from the destination and may give priority levels to those points.

For example, the controlling portion 21 sets a priority level “1” to a point present within the given distance range and having a right-door-open time average value equal to or more than the time threshold. Further, the controlling portion 21 sets a priority level “2” to a point present within the given distance range and having a sum value of the number of times of right-door opening that is equal to or more than the number-of-times threshold, and sets a priority level “3” to a point present within the given distance range and having a left-door-open time average value equal to or more than the time threshold. Then, the controlling portion 21 sets a priority level “4” to other points. Further, in this case, the second in-vehicle system 30 may display the alighting points such that their priority levels are identifiable. For example, the second in-vehicle system 30 may display the alighting points with different colors according to the priority levels on a map. Note that, as the value of the priority level is smaller, the point has a higher priority.

The present embodiment assumes a case of providing a guide to an alighting point for occupants other than a driver. As another example, the alighting point guide system 20 may provide a guide to an alighting point for occupants including a driver. In this case, the controlling portion 21 should register statistic values for the driver seat in the boarding-alighting table 223 and may determine an alighting point as a guide target based on the statistic values of doors including the driver seat.

Further, in the present embodiment, the alighting point guide system 20 selects an alighting point from points present within the given distance range from the destination. However, a range including process target points is not limited to this. As another example, the alighting point guide system 20 may select an alighting point from points present within a range based on the vehicle position of the vehicle provided with the second in-vehicle system 30. Thus, the alighting point guide system 20 should select an alighting point from points present within a range based on a given point.

The alighting point guide system 20 may determine the priority levels based on the distance from the destination, the sum value of the number of times of door opening, and the door-open time average value and may select, as the alighting point, a point the priority level of which is equal to or more than a threshold, with reference to a point the priority level of which is less than the threshold. In this case, a function to be used herein is a function that increases the priority level of a point as the distance of the point from the destination is shorter, increases the priority level of a point as the door-open time average value at the point is longer, and increases the priority level of a point as the sum value of the number of times of door opening at the point is larger. Further, in the function, more weight is given to the door-open time average value than the sum value of the number of times of door opening. Hereby, a point with a large door-open time average value is selected with preference to a point with a large sum value of the number of times of door opening.

Further, the alighting point guide system 20 of the present embodiment manages the same link as the same point, but a predetermined range should be regarded as the same point, and a unit of a point is not limited to a link. As another example, the alighting point guide system 20 may determine points within a predetermined distance range as the same point.

Further, as another example, the alighting point guide system 20 may register boarding-alighting tables for different periods such as time ranges or days of the week, for example. In a case where the alighting point guide system 20 acquires an alighting point guide request, the alighting point guide system 20 may provide a guide to an alighting point selected by referring to a boarding-alighting table corresponding to an expected time of arrival at the destination. Hereby, even in a case where a point for parking or stopping, the frequency of parking or stopping, or the like varies depending on an alighting timing such as a day of the week, for example, the alighting point guide system 20 can provide a guide to a point suitable for alighting as the alighting point.

Further, the above system can be applied to a program or a method. Further, such a program or method may be implemented as an independent device or may be implemented by a plurality of devices by use of common parts, and various forms are included. Further, the program or method can be modified appropriately such that some of the program or method is implemented by software or some of the program or method is implemented by hardware. Further, the disclosure is also achievable as a recording medium for a program for controlling the system. Of course, the recording medium for the program may be a magnetic recording medium or a semiconductor memory, and the same can apply to any type of recording media to be developed in future.

What is claimed is:

1. An alighting point guide system comprising:
an acquisition portion configured to acquire an alighting point guide request from an occupant of a vehicle; and
a guide portion configured to provide a guide to an alighting point, wherein, in a case where the number of occupants of the vehicle as a transmission source of the alighting point guide request is larger than a reference number set in advance, the guide portion selects, as the alighting point, a point where at least either one value of a statistic value about a door-open time detected previously and a statistic value about the number of times of door opening that is detected previously is equal to or more than a threshold with preference to a point where the at least either one value is less than the threshold, the door-open time being a period during which a door of a vehicle is opened, the number of times of door opening being the number of times a door of a vehicle is opened.

2. The alighting point guide system according to claim 1, wherein
the vehicle includes a plurality of the doors, and
the door-open time is a time during which a door on an on-coming lane side among the doors is opened.

3. The alighting point guide system according to claim 1, wherein
the vehicle includes a plurality of the doors, and
the number of times of door opening is the number of times a door on an on-coming lane side among the doors is opened.

4. The alighting point guide system according to claim 1, wherein:
a point where the statistic value about the door-open time is equal to or more than a time threshold is selected as the alighting point with preference to a point where the statistic value about the door-open time is less than the time threshold;
a point where the statistic value about the number of times of door opening is equal to or more than a number-of-times threshold is selected as the alighting point with preference to a point where the statistic value about the number of times of door opening is less than the number-of-times threshold; and
the point where the statistic value about the door-open time is equal to or more than the time threshold is selected as the alighting point with preference to the point where the statistic value about the number of times of door opening is equal to or more than the number-of-times threshold.

5. The alighting point guide system according to claim 1, wherein a point where a variation degree in the statistic value about the door-open time detected previously is smaller than a variation threshold is selected as the alighting point with reference to a point where the variation degree is equal to or more than the variation threshold.
